(19) United States
(12) Patent Application Publication
(10) Pub. No.: US 2024/0205598 A1
(43) Pub. Date: Jun. 20, 2024

(54) PROXIMATE DUAL MEMS MICROPHONES, SYSTEMS, DEVICES, AND METHODS

(71) Applicants: Dean Robert Gary Anderson, Orem, UT (US); Dean Gregory Anderson, Vernal, UT (US); Daniel Anderson, Chandler, AZ (US)

(72) Inventors: Dean Robert Gary Anderson, Orem, UT (US); Dean Gregory Anderson, Vernal, UT (US); Daniel Anderson, Chandler, AZ (US)

(21) Appl. No.: 18/534,686

(22) Filed: Dec. 10, 2023

Related U.S. Application Data
(60) Provisional application No. 63/432,683, filed on Dec. 14, 2022.

(51) Int. Cl. H04R 3/00

(52) U.S. Cl. CPC H04R 3/005; H04R 2201/003

(57) ABSTRACT

In one embodiment of an audio system, the audio system comprises signal summation of two MEMS microphones in close acoustical proximity for speech frequencies to provide various benefits and improvements, including improvements to: speech intelligibility, signal-to-noise ratio, effective equivalent input noise, and at-a-distance acoustic signal reception.

### CROSS-REFERENCE TO RELATED APPLICATION

The present application claims the benefit of priority from U.S. Provisional Application No. 63/432,683, filed on Dec. 14, 2022, which is hereby incorporated by reference.

### BACKGROUND

Dean R. G. Anderson is the epitome of a “garage inventor.” Over the past 28 years Dean has worked tirelessly from his home conducting research, and developing products, in a variety of technology fields. In 1994, Dean developed a novel image processing algorithm which he implemented in software to improve the quality of color printers. Around 1997, Dean began developing a new technology that enabled large format printers to print with oil paints in lieu of costly inks. Dean was awarded eight U.S. patents directed to his inventions covering these printing technologies. These patents were later sought-after and acquired by a multinational Fortune 100 company.

In 2006, Dean turned his research focus toward engraving technology and began developing software to facilitate the creation of digital images that could be used to generate engraving plates. Again, Dean was granted a U.S. patent covering his unique innovations.

Beginning in 2009, Dean decided to look into the field of audiology. His wife, Linda, has profound hearing loss and was unhappy with the performance of her hearing aids. Over the course of decades, she had tried numerous different brands of hearing aids and spent thousands of dollars, but still had a very difficult time understanding speech.

Their son, Dean G. Anderson, a medical doctor, joined his father's research efforts beginning in 2010. Together, father and son, Dean and Dean researched the physiology of hearing, speech and linguistics, psychoacoustics, the physics of sound, the acoustic properties of materials, signal processing, and the engineering of audio devices and systems.

Over the following years, Dean and Dean were awarded more than a dozen patents covering methods, devices, and systems for measuring hearing loss, fitting hearing aids, processing analog and digital signals, generating synthetic speech signals, passive amplification, and improving the speech intelligibility of audio generated by devices and systems. They were assisted in their patenting efforts by another of Dean's sons, Daniel J. Anderson, who became a patent attorney in 2013.

As a family, the Andersons have worked together to develop and protect revolutionary audio technology that has already helped many individuals to enjoy better hearing, and most importantly, to understand speech again. Many of these innovations, including those described herein, are also applicable to the fields of machine hearing, artificial intelligence, and natural language processing.

This present invention relates, in general, to electronics and, more particularly, to audio systems that comprise signal summation of at least two MEMS microphones in close acoustical proximity (“proximate dual microphones”).

Microphones are transducers that convert sound energy into an electrical signal. Microphone self-noise, also known as equivalent input noise (“EIN”), is an electrical signal which a microphone produces of itself. Microphone EIN is constant and occurs even when no sound source is present. Microphone EIN is a problem in many audio systems because it introduces unwanted noise and decreases the signal-to-noise ratio (“SNR”) of a microphone. For example, the noise generated by microphone EIN can be distracting to users of audio systems and can make it difficult for users of an audio system to understand the intended signal. Generally, microphones that are rated with lower EIN and higher SNR are expensive, large diaphragm, condenser-type microphones.

Micro-ElectroMechanical Systems (“MEMS”) microphones are variants of the condenser microphone design. In a MEMS microphone, a pressure-sensitive diaphragm can be etched directly into a silicon wafer by MEMS processing techniques. MEMS microphones can be very small and inexpensive. Conventional MEMS microphones, however, suffer from relatively high EIN figures.

EIN levels are independent of the distance between a microphone and a sound source. However, an audio signal of interest (e.g., speech at a sustained vocal effort) attenuates according to the inverse square law (e.g., the signal attenuates by 6 dB every time the distance between the speaker's mouth and the microphone doubles). Furthermore, speech cues, and their relative intensity, are not equally distributed across the frequency bands used for speech. For example, the 160 Hz ⅓ octave band contributes less than 1% of the total speech cues whereas the 2000 Hz ⅓ octave band contributes almost 9% of total speech cues. The high frequency components of speech (i.e., ⅓^{rd} octave bands for 1000 Hz and above) contribute to 70.1% of the total speech intelligibility index. However, the standard speech spectrum levels for these high frequency bands are lower than the vocalized (lower frequency) portions of speech. As a result of all the above, conventional microphone EIN can approach and even exceed speech signal levels at higher frequencies under common conditions. For example, the EIN levels of common hearing aid microphones may exceed the levels of speech signals at frequencies above 4,000 Hz when the microphone is located one meter away from a speech source having an overall speech level of about 62 dB. As another example, the EIN levels of common hearing aid microphones may exceed the levels of speech signals at frequencies above 2,500 Hz when the microphone is located two meters away from a speech source having an overall speech level of about 62 dB.

Conventional MEMS microphones are also omni-directional, meaning that they show no preference for incoming signal direction. In order to achieve directional preference, designers employ beamforming techniques using two or more MEMS microphones. For example, in a conventional beamforming endfire array, each microphone is separated by a fixed distance (e.g., 10-75 mm). The signal from the first microphone is delayed by an amount of time and subtracted (or inverted and summed) from the second microphone's signal. This subtraction always attenuates the resulting signal. The degree of attenuation depends on the phase relationship between the two microphone signals which in turn depends on the direction of the original audio signal source relative to the two microphones. As a result, the array of microphones may achieve directional sensitivity, which improves the signal-to-noise ratio between a signal coming from one direction and noise coming from another. Notably, however, the use of two or more MEMS microphones also increases the proportion of EIN relative to the attenuated signal and results in a lower SNR as between the desired signal and the EIN. This effect is amplified when both a desired signal and environmental noise are coming from the same or substantially the same direction.

Accordingly, it is desirable to have a low-cost MEMS microphone system that exhibits, among other things, high SNR and low effective EIN. It would be beneficial for such a system to excel at both far-field and near-field audio applications. Furthermore, it would be beneficial for such a system to be physically configured to achieve high manufacturability and compact dimensions for small applications. Moreover, it would be beneficial to reduce or eliminate the additional signal processing required by various beamforming techniques.

### BRIEF DESCRIPTION OF THE DRAWINGS

FIG. 1A illustrates a cross-section side view of a MEMS microphone in accordance with the present description:

FIG. 1B illustrates a bottom view of a MEMS microphone in accordance with the present description:

FIG. 1C illustrates a top view of a printed circuit board (“PCB”) in accordance with the present description:

FIG. 1D illustrates a side view of a proximate dual microphone system in accordance with the present description:

FIG. 1E illustrates a schematic diagram of a proximate dual microphone system in accordance with the present description:

FIG. 2A illustrates a side view of a MEMS microphone in accordance with the present description:

FIG. 2B illustrates a bottom view of a MEMS microphone in accordance with the present description:

FIG. 2C illustrates a top view of a PCB in accordance with the present description:

FIG. 2D illustrates a side view of a proximate dual microphone system in accordance with the present description:

FIG. 2E illustrates a schematic diagram of a proximate dual microphone system in accordance with the present description:

FIG. 3A illustrates a side view of a MEMS microphone in accordance with the present description:

FIG. 3B illustrates a bottom view of a MEMS microphone in accordance with the present description:

FIG. 3C illustrates a top view of a PCB in accordance with the present description:

FIG. 3D illustrates a side view of a proximate dual microphone system in accordance with the present description:

FIG. 3E illustrates a schematic diagram of a proximate dual microphone system in accordance with the present description:

FIG. 4A illustrates a perspective view of an audio system in accordance with the present description:

FIG. 4B illustrates a cross-section view of an audio system in accordance with the present description:

FIG. 5A illustrates a cross-section side view of a proximate dual microphone system in accordance with the present description:

FIG. 5B illustrates a cross-section top view of a proximate dual microphone system in accordance with the present description:

FIG. 5C illustrates a schematic diagram of a proximate dual microphone system in accordance with the present description:

FIG. 6A illustrates a cross-section side view of a MEMS microphone in accordance with the present description:

FIG. 6B illustrates a bottom view of a MEMS microphone in accordance with the present description:

FIG. 6C illustrates a top view of a printed a PCB in accordance with the present description:

FIG. 6D illustrates a side view of a proximate dual microphone system in accordance with the present description: and,

FIG. 6E illustrates a schematic diagram of a proximate dual microphone system in accordance with the present description.

The elements in the figures are illustrated for simplicity and clarity and have not necessarily been drawn to scale. Some elements in the figures may be exaggerated or minimized relative to other elements in order to help improve the understanding of the embodiments described herein. The same reference numbers in different figures may denote the same elements.

### DETAILED DESCRIPTION

The drawings and detailed description are provided in order to enable a person skilled in the applicable arts to make and use the invention. The drawings and detailed description may focus on specific implementations and embodiments; however, these specific implementations and embodiments are provided as examples and are not intended to restrict the scope of this disclosure. Descriptions and details of well-known steps and elements are omitted for simplicity of the description.

As used herein, the term and or includes any and all combinations of one or more of the associated listed items. As used herein, the verbs comprise, include and/or contain, when used in this specification and/or claims, are intended to specify a non-exclusive inclusion of the stated features, elements, steps and/or components, and do not preclude the presence or addition of one or more other features, elements, steps and/or components. It will be understood that, although the terms first, second, etc. may be used herein to describe various features, elements, values, ranges, steps, components and/or dimensions, these features, elements, ranges, values, steps, components, and/or dimensions should not be limited by these terms. The terms first, second, etc. are only used to distinguish one feature, element, range, value, step, component, and/or dimension from another. Thus, for example, a first element or a first dimension as described below, could also be termed as a second element or a second dimension without departing from the teachings of the present disclosure.

Reference to “one embodiment” or “an embodiment” means that a particular feature, structure, or characteristic described in connection with the embodiment is included in at least one embodiment of the present disclosure. Thus, appearances of the phrases “in one embodiment” or “in an embodiment” in various places throughout this specification are not necessarily all referring to the same embodiment, but in some cases they may.

The use of words about, approximately, generally, or substantially means a value of an element is expected to be close to a stated value or position. However, as is well known in the art there are always minor variances preventing values or positions from being exactly stated. At a minimum, values within +/−10% of a stated value can be considered about, approximately, generally, or substantially equal to a stated value.

It is further understood that the embodiments illustrated and described hereinafter suitably may be practiced in connection with elements that are not specifically disclosed herein. Furthermore, it is understood that embodiments illustrated and described hereinafter also include variations wherein one or more of the illustrated or described elements may be omitted.

Generally speaking, speech frequencies comprise frequencies between about 100 Hz to about 9000 Hz. For example, speech frequencies can be described by 18 one-third octave bands having the following nominal midband frequencies: 160 Hz, 200 Hz, 250 Hz, 315 Hz, 400 Hz, 500 Hz, 630 Hz, 800 Hz, 1000 Hz, 1250 Hz, 1600 Hz, 2000 Hz, 2500 Hz, 3150 Hz, 4000 Hz, 5000 Hz, 6300 Hz, and 8000 Hz. For conditions when the speed of sound in air is 343 meters/second, the 18 one-third octave bands have the following corresponding wavelengths: 214.4 centimeters (“cm”), 171.5 cm, 137.2 cm, 108.9 cm, 85.7 cm, 68.6 cm, 54.4 cm, 42.9 cm, 34.3 cm, 27.4 cm, 21.4 cm, 17.1 cm, 13.7 cm, 10.9 cm, 8.6 cm, 6.9 cm, 5.4 cm and 4.3 cm, respectively. According to ANSI S3.5-1997, American National Standard Methods of Calculation of the Speech Intelligibility Index (“SII”), the 18 one-third octave bands are given band importance weightings: 0.0083, 0.0095, 0.015, 0.0289, 0.044, 0.0578, 0.0653, 0.0711, 0.0818, 0.0844, 0.0882, 0.0898, 0.0868, 0.0844, 0.0771, 0.0527, 0.0364 and 0.0185, respectively. It is noted that the sum of the 18 band importance weightings equals 1.0000.

A difference of 5 millimeters (“mm”) or less between two physical lengths for air-conduction sound propagation for speech frequencies are considered to be effectively in-phase and coherent with respect to a speech audio source after SII band importance weighting considerations are made. Two microphones separated by a distance of 5 millimeters (“mm”) or less are considered to generate signals that are effectively in-phase and coherent with respect to speech frequencies emanating from a sound source located at any point in space. Such microphones are described herein as “proximate dual MEMS microphones,” “proximate dual microphones,” “proximate MEMS microphones,” or “proximate microphones.” As used herein the term “dual,” as in the phrase “proximate dual microphones,” is intended to describe two or more microphones.

Generally speaking, far-field speech distance can be a distance of about 70 cm or greater between a microphone and a sound source. Near-field speech distance can be a distance less than 70 cm between a microphone and a sound source.

Generally speaking, the terms audio device or audio system can refer to a stand-alone system or a subcomponents or subsystem of a larger system. A non-limiting list of example audio systems and audio devices where the invention described herein may find application, includes: microphones, sensors, receivers, amplifiers, sound detectors, acoustic transducers, audio and/or video conferencing systems, audio recording systems, security and surveillance systems and tools, far-field audio detection and recording, smart speakers, radios, telephones, hearing aids, over-the-counter hearing aids, hearables, wearables, personal sound amplifiers, built-in microphone systems, MEMS microphones, cell phones, smart phones, camcorders, video cameras, instruments with acoustic microphones, tablets, computers, laptops, televisions, vehicle infotainment systems, headsets, voice controlled systems, voice activated systems, acoustic virtual reality systems, machine hearing systems, artificial intelligence systems, natural language processing systems, acoustic detectors, autonomous vehicle systems and/or methods, and subsystems within any of the above devices or systems. The examples and embodiments described herein can be applied to, or used within, any of the above-described audio devices or systems.

Multiple instances of examples or embodiments described or illustrated herein may be used within a single audio device or system. As an example, multiple instances of embodiments described or illustrated herein may enable a stereo audio device comprising a first instance of an embodiment for a right proximate dual MEMS microphone and a second instance of an embodiment for a left proximate dual MEMS microphone. In another example, multiple instances of embodiments described or illustrated herein may enable a virtual reality audio device comprising multiple instances of an embodiment with multiple passive acoustic directional amplifiers with proximate dual MEMS microphones. In another example, multiple instances of embodiments described or illustrated herein may enable acoustic location systems and acoustic ranging systems.

The inventor is fully informed of the standards and application of the provisions of 35 U.S.C. § 112(f). Thus, the use of the words “function,” “means” or “step” in the Detailed Description or claims is not intended to somehow indicate a desire to invoke the provisions of 35 U.S.C. § 112(f) to define the invention. To the contrary, if the provisions of 35 U.S.C. § 112(f) are sought to be invoked to define the inventions, the claims will specifically and expressly state the exact phrases “means for” or “step for” and the specific function, without also reciting in such phrases any structure, material or act in support of the function. Thus, even when the claims recite a “means for . . . ” or “step for . . . ” if the claims also recite any structure, material, or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the illustrated embodiments, but in addition, include any and all structures, materials, or acts that perform the claimed function as described in alternative embodiments or forms of the invention, or that are well known present or later-developed, equivalent structures, material, or acts for performing the claimed function.

In the following description, and for the purposes of explanation, numerous, specific details are set forth in order to provide a thorough understanding of the various aspects of the invention. It will be understood, however, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software, hardware or a combination of both. It should be noted that there are many different and alternative configurations, devices, and technologies to which the disclosed inventions may be applied. Thus, the full scope of the invention is not limited only to the examples that are described herein.

It is noted that sound waves can be longitudinal waves because the constituent components (particles) of a medium through which a sound wave is propagated vibrate in a direction generally parallel to the direction that the sound wave propagates. These back-and-forth vibrations are imparted to adjacent neighbors by particle-to-particle interaction.

Sound pressure levels can be measured in units called decibels (abbreviated as “dB”). Sound levels diminish as the distance between a sound source and the sound receiver increases. For example, conversational speech measured as 65 dB at 50 centimeters away from a speaker is measured at 45 dB when measured from 500 centimeters away. Human speech is typically comprised of voiced and unvoiced sounds that are produced at a wide variety of frequencies.

A critical band is a band of audio frequencies where the perception of one tone will interfere with the perception of a second tone due to auditory masking. Critical bands have about ⅓ octave bandwidths.

The sensitivity of a microphone can be described as the electrical response at its output to a given standard acoustic input. The sensitivity tolerance between MEMS microphones can be about #1 dB, enabling high-performance dual microphone systems to be constructed without the need for system sensitivity calibration.

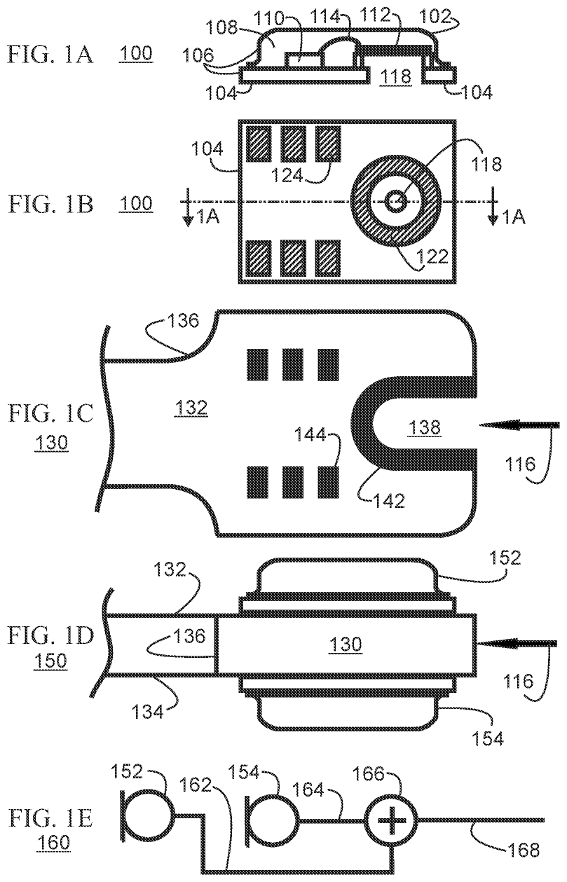

FIG. 1A illustrates a cross-sectional side view of a MEMS microphone 100 along line 1A shown in FIG. 1B. According to some examples, MEMS microphone 100 may comprise any conventional MEMS microphone. In one example, MEMS microphone 100 includes a housing or a case 102. Housing 102 can be mounted or affixed to a substrate 104. In one example, substrate 104 includes a printed circuit board (“PCB”). In one example, housing 102 can also be integral with substrate 104. Together, housing 102 and substrate 104 form MEMS package 106.

Housing 102 defines an interior cavity, volume or chamber 108 between housing 102 and substrate 104. Cavity 108 contains an integrated circuit (“IC”) 110, such as an application specific integrated circuit (“ASIC”), and a MEMS sensor 112. In one example, IC 110 and MEMS sensor 112 can also be parts of a single structure. IC 110 and MEMS sensor 112 can be affixed to substrate 104. In one example, IC 110 and MEMS sensor 112 are affixed using a die attach material. IC 110 and MEMS sensor 112 can be electronically coupled with bond wire(s) 114. Substrate 104 can include electrical contacts such as electrical contacts 122 and 124 and located at the bottom of substrate 104 (see FIG. 1B). According to one embodiment, contacts such as 122 and 124 are configured to electronically couple MEMS microphone 100 to other electronic devices. In one example, IC 110 is electronically coupled to electrical contacts 124 by way of conductive via(s) that interconnect the top of substrate 104 to electrical contacts such as electrical contacts 124 and 122 located at the bottom of substrate 104. In one example, IC 110 can be electronically coupled to conductive via(s) by way of bond wire(s).

According to various embodiments, MEMS package 106 forms a sound port, sound inlet, or port hole 118. Sound port 118 allows air-conducting sound to enter MEMS microphone 100 and be converted into a first electrical signal 162 (see FIG. 1E) representing the sound. In one example, sound port 118 can be formed by substrate 104 through which air-conduction sound reaches MEMS sensor 112. This is an example of a bottom port MEMS microphone. In another example, there is no sound port in substrate 104, and the sound port is formed in housing 102. This is an example of a top port MEMS microphone or a side port MEMS microphone.

In one example, MEMS microphone 100 is a bottom port MEMS microphone comprising a MEMS sensor 112, and integrated circuit 110 which includes circuitry for signal conditioning, an analog-to-digital converter, decimation and anti-aliasing filters, power management, and an industry standard 24-bit I²S interface. In one example, MEMS sensor 112 comprises a pressure sensitive diaphragm.

In another example, MEMS sensor 112 and IC 110 be formed on a single semiconductor die such that the die comprises both the diaphragm and the circuitry for signal conditioning, analog-to-digital conversion, decimation and anti-aliasing filters, power management, and an industry standard 24-bit I²S interface.

FIG. 1B illustrates a bottom view of MEMS microphone 100. In one example MEMS microphone 100 measures 3 mm by 4 mm. In the present example, MEMS microphone 100 has a bottom port opening 118 through which air-conducting sound can enter MEMS microphone 100 and be converted into first electrical signal such as electrical signal 162 (see FIG. 1E). First MEMS microphone 100 has electrical contacts 122 and 124. In one example, electrical contacts 122 and 124 can be surface mount electrical connections. In one example, electrical contact 122 is the electrical ground connection for MEMS microphone 100. In one example, electrical contacts 122 and 124 are metal leads. In another example, electrical contacts 122 and 124 are solder bumps.

According to various embodiments, MEMS microphone 100 has a sound port 118. In one example, sound port 118 is formed by substrate 104. In another example, sound port 118 is formed by package 106. In another example, a sound port can be formed by housing 102 and located on top of packaging 106. Sound port 118 may be completely devoid of material or alternatively may incorporate a screen or mesh.

FIG. 1C illustrates a top view of a substrate 130. Substrate 130 has a top surface 132 and a bottom surface 134 opposite the top surface as shown in FIG. 1D. Substrate 130 has an edge surface 136 that extends from top surface 132 to bottom surface 134. In one embodiment, edge surface 136 of substrate 130 forms an open-ended slot, slotted recess, or concave recess 138 extending into substrate 130. Air-conducting sound 116 can enter slotted or concave recess 138 of substrate 130.

In one example, substrate 130 is a PCB. Substrate 130 can have electrical contacts such as electrical contacts 142 and 144. Electrical contacts 142 and 144 are shown using solid black filled markings. In one example, electrical contacts 142 and 144 are surface mount electrical pad connections. In another example, electrical contact 142 is a plated through-slot contact and electrical contacts 144 are plated through-hole contacts. In one example, surface mount electrical pad connection 142 is a plated-through, open-ended slot for electrical ground connection.

Substrate 130 can be a double-sided PCB and can have similar surface mount electrical pad connections in a mirror arrangement on bottom surface 134 of substrate 130. Electrical PCB trace interconnections to electrical pad connections such as 142 and 144 are not shown for simplicity of the description. Similarly, other features such as solder mask layers have been omitted for simplicity.

FIG. 1D illustrates a side view of a proximate dual microphone system 150 comprising a first MEMS microphone 152 and a second MEMS microphone 154. According to some examples, each of first and second MEMS microphones 152 and 154 are a conventional MEMS microphone. In one example, each of first and second MEMS microphones 152 and 154 are bottom port MEMS microphones similar to MEMS microphone 100. In another example, proximate dual microphone system 150 also comprises a double-sided PCB substrate such as substrate 130. First MEMS microphone 152 can be mounted or affixed to top surface 132 of substrate 130 such that its bottom sound port 118 is positioned over slotted or concave recess 138 of substrate 130. Furthermore, second MEMS microphone 154 can be mounted or affixed to bottom surface 134 of substrate 130) such that its bottom sound port 118 is positioned over slotted or concave recess 138 of substrate 130. In one example, substrate 130 is about 1.6 mm thick, as a result the sound ports of MEMS microphones 152 and 154 are positioned less than 3 mm apart from each other. In another example, substrate 130 is less than 1 mm thick, as a result the sound ports of MEMS microphones 152 and 154 are positioned less than 1 mm apart from each other. In another example, the sound ports of MEMS microphone 152 and 154 are positioned less than 5 mm apart. As a result, air-conduction sound 116 has nearly identical far-field acoustic path lengths from any point in space to each of the sound port openings of MEMS microphones 152 and 154. This is particularly the case for frequencies within the range of human speech.

FIG. 1E illustrates a schematic diagram 160 for proximate dual microphone system 150. Proximate dual microphone system 150 comprises first MEMS microphone 152 which generates first signal 162, and second MEMS microphone 154 which generates a second signal 164. System 150 illustrates that first signal 162 and second signal 164 are added together 166 to create a summation signal 168. It is noted that schematic diagram 160 representing proximate dual microphone system 150 contains no delay element: thus, first electrical signal 162 and second electrical signal 164 are in-phase and coherent with respect to a speech source. As a result, the summation signal 168 for a speech source will be about 6 dB greater than either of the in-phase and coherent components of signals 162 or 164 for a speech source.

On the other hand, EIN produced by first MEMS microphone 152 and EIN produced by second MEMS microphone 154 are incoherent and uncorrelated. As a result, these microphone self-noises will increase by only about 3 dB in summation signal 168. Thus, proximate dual microphone system 150 can increase the SNR by 3 dB with respect to EIN as compared to a system comprising only a single MEMS microphone. Proximate dual microphone system 150 lowers the effective EIN by 3 dB with respect to a desired signal. These effects become increasingly important for speech intelligibility in the far-field especially for high frequency components of a speech source. With no delay element in proximate dual microphone system 150, proximate dual microphone system 150 will exhibit an omnidirectional polar pattern for speech frequencies.

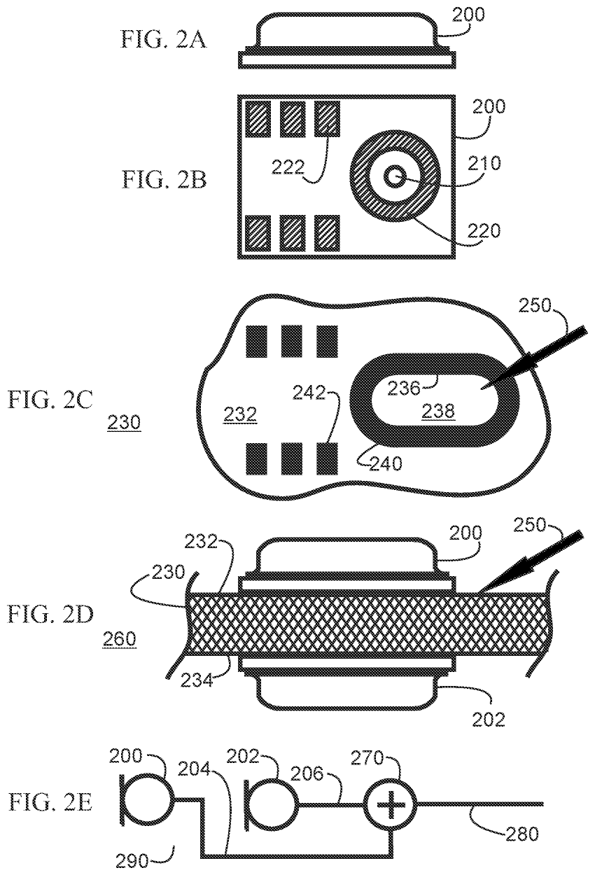

FIG. 2A illustrates a side view of a first MEMS microphone 200 that can be used in conjunction with a second MEMS microphone 202 as described hereinafter. According to some examples, MEMS microphones 200 and 202 may comprise any conventional MEMS microphones. In one example MEMS microphone 200 is similar to MEMS microphone 100 of FIG. 1A. In one example, MEMS microphone 200 is 1 mm thick. In one example, MEMS microphone 200 is a bottom port MEMS microphone including a MEMS sensor, and an IC for signal conditioning, an analog-to-digital converter, decimation and anti-aliasing filters, power management, and an industry standard 24-bit I²S interface.

In one example, the MEMS sensor and IC within MEMS microphone 200 can be formed on a single semiconductor die such that the die comprises both the diaphragm and circuitry for signal conditioning, analog-to-digital conversion, decimation and anti-aliasing filters, power management, and an industry standard 24-bit I²S interface

FIG. 2B illustrates a bottom view of MEMS microphone 200. In one example MEMS microphone 200 measures 3 mm by 4 mm. In the present example, MEMS microphone 200 has a bottom sound port 210 through which air-conducting sound can enter MEMS microphone 200 and be converted into a first electrical signal 204 (see FIG. 2E). MEMS microphone 200 has electrical contacts such as electrical contacts 220 and 222. Electrical connections 220 and 222 are shown here with diagonal hatching markings. In one example electrical contacts 220 and 222 are surface mount electrical connections. In another example, electrical contacts 220 and 222 include electrical leads. In yet another example, electrical contacts 220 and 222 comprise solder bumps. Electrical contacts 220 and 222 are configured to enable MEMS microphone 200 to electronically couple with other electronic devices. In one example, electrical contact 220 is the electrical ground connection for MEMS microphone 200.

FIG. 2C illustrates a top view of a PCB 230. PCB 230 has electrical contacts such as electrical contacts 240 and 242. Electrical contacts 240 and 242 are shown here using solid black filled markings. In one example, electrical contacts can be surface mount electrical pad connections. In another example electrical contacts 240) and 242 can be plated through-hole contacts. In one example, electrical contact 240 is a plated-through, slotted hole for electrical ground connection. In one example, PCB 230 is a double-sided PCB and is 1.0 mm thick. In one example, PCB 230 has similar surface mount electrical pad connections in a mirror arrangement on the bottom side of PCB 230 (not shown). PCB 230 has an edge surface 236 that extends from top surface 232 to bottom surface 234. In one embodiment, edge surface 236 of PCB 230 forms an opening, hole, or slotted hole 238 extending through PCB 230. Air-conducting sound 250 can enter slotted hole 238 of PCB 230. Electrical PCB trace interconnections to electrical pad connections are not shown for simplicity of the description. Similarly, other features such as solder mask layers have been omitted for simplicity.

FIG. 2D illustrates a side view of a proximate dual microphone system 260 as generally indicated with a first MEMS microphone 200, a second MEMS microphone 202 similar to first MEMS microphone 200 producing a second electrical signal 206 (see FIG. 2E), and PCB 230. MEMS microphone 200 can be positioned or mounted to top surface 232 of PCB 230 and MEMS microphone 202 can be positioned or mounted to bottom surface 234 of PCB 230. In one example, MEMS microphone 200 is mounted to the top surface 232 of PCB 230 such that a bottom sound port 210 of first MEMS microphone 200 is positioned over slotted hole 238 of PCB 230. Furthermore, second MEMS microphone 202 is mounted to the bottom surface 234 of PCB 230 such that a bottom sound port 210 of second MEMS microphone 202 is positioned over slotted hole 238. Both first MEMS microphone 200 and second MEMS microphone 202 are positioned so that air-conduction sound 250 has nearly identical acoustic path lengths for speech frequencies into the port openings of each of the MEMS microphones. In one example, first MEMS microphone 200 is positioned so that it does not cover the entirety of slotted hole 238 or such that at least a portion of slotted hole 238 remains uncovered by first MEMS microphone 200. Similarly, second MEMS microphone 202 can be positioned so that it does not cover the entirety of slotted hole 238 or such that at least a portion of slotted hole 238 remains uncovered by second MEMS microphone 202.

In one example, substrate 230 is about 1.6 mm thick, as a result the sound ports of MEMS microphones 200 and 202 are positioned less than 3 mm apart from each other. In another example, substrate 230 is less than 1 mm thick, as a result the sound ports of MEMS microphones 200 and 202 are positioned less than 1 mm apart from each other. In another example, the sound ports of MEMS microphone 200 and 202 are positioned less than 5 mm apart. As a result of any of the above embodiments, air-conduction sound 250 has nearly identical far-field acoustic path lengths from any point in space to the sound port openings of MEMS microphones 200 and 202. This is particularly the case for frequencies within the range of human speech.

FIG. 2E illustrates a schematic function diagram 290 as generally indicated of proximate dual microphone system 260 which includes first MEMS microphone 200, first electrical signal 204, second MEMS microphone 202 and second electrical signal 206. Schematic function diagram 290 illustrates that first electrical signal 204 and second electrical signal 206 are added together 270 to create a summation electrical signal 280. It is noted that schematic function diagram 290 contains no delay element: thus, first electrical signal 204 and second electrical signal 206 are in-phase and coherent with respect to a speech audio source. The summation electrical signal 280 of first electrical signal 204 and second electrical signal 206 causes an in-phase and coherent speech audio signal level of interest to increase by 6 dB. First MEMS microphone 200 produces a first EIN. Similarly, second MEMS microphone 202 produces a second EIN. First EIN and second EIN are incoherent and uncorrelated and consequentially the summation of the first and second EIN will result in only an increase of about 3 dB of EIN within the resulting electrical summation signal 280. Thus, proximate dual microphone system 260 increases the SNR by 3 dB with respect to EIN. Proximate dual microphone system 260 lowers the effective EIN by 3 dB with respect to a speech audio signal. These effects become increasingly important for speech intelligibility in the far-field. With no delay element in schematic function diagram 290, a proximate dual microphone system 260 will exhibit an omnidirectional polar pattern for speech frequencies.

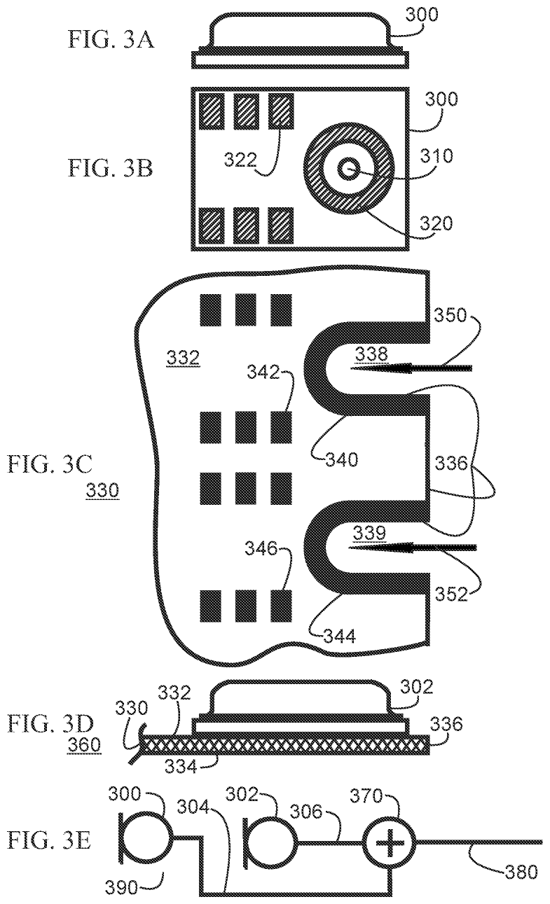

FIG. 3A illustrates a side view of a first MEMS microphone 300 that can be used in conjunction with a second MEMS microphone 302 as described hereinafter. According to some examples, MEMS microphones 300 and 302 may comprise any conventional MEMS microphone. In one example first MEMS microphone 300 is 1 millimeter (mm) thick. In one example, first MEMS microphone 300 is a bottom port MEMS microphone which includes MEMS sensor, signal conditioning, an analog-to-digital converter, decimation and anti-aliasing filters, power management, and an industry standard 24-bit I²S interface. Alternatively, first MEMS microphone 300 may be a top port or a side port MEMS microphone. In yet another example, first MEMS microphone 300 has a sound port interface configured with port tubing.

In one example, the MEMS sensor and IC within MEMS microphone 300 can be formed on a single semiconductor die such that the die comprises both the diaphragm and circuitry for signal conditioning, analog-to-digital conversion, decimation and anti-aliasing filters, power management, and an industry standard 24-bit I²S interface

FIG. 3B illustrates a bottom view of first MEMS microphone 300. In one example first MEMS microphone 300 measures 3 mm by 4 mm. In the present example, first MEMS microphone 300 has a bottom port or sound port opening 310 through which air-conducting sound can enter first MEMS microphone 300 and be converted into a first electrical signal 304 (see FIG. 3E). First MEMS microphone 300 has surface mount electrical connections such as 320 and 322. Surface mount electrical connections such as 320 and 322 are shown here with diagonal hatching markings. In one example, surface mount electrical connection 320 is the electrical ground connection for first MEMS microphone 300.

FIG. 3C illustrates a top view of a PCB 330. PCB 330 has surface mount electrical pad connections such as 340 and 342 for first MEMS microphone 300 and electrical pad connections such as 344 and 346 for second MEMS microphone 302 as described hereinafter. Surface mount electrical pad connections such as 340, 342, 344 and 346 are shown here using solid black filled markings. In one example, surface mount electrical pad connections 340 and 344 are plated-through, open-ended slots for electrical ground connections. PCB 330 has an edge surface 336 that extends from top surface 332 to bottom surface 334 (see FIG. 3D). In one embodiment, edge surface 336 of PCB 330 forms a first open-ended slot, slotted recess, or concave recess 338 extending into PCB 330. Air-conducting sound 350 can enter first slotted or concave recess 338 of PCB 330. In another embodiment, edge surface 336 of PCB 330 forms a second open-ended slot, slotted recess, or concave recess 339 extending into PCB 330. Air-conducting sound 352 can enter second slotted or concave recess 339 of PCB 330.

PCB 330 may be any type of PCB, for example PCB 330 may be a double-sided PCB, a flexible (e.g., polyimide) circuit board, a multilayer circuit board, and/or an aluminum substrate circuit board circuit board. Air-conducting sound 350 and 352 can enter the port openings 310 of first MEMS microphone 300 and second MEMS microphone 302 through first slotted or concave recess 338 and second slotted or concave recess 339 respectively. Sound may also enter via other means such as tubing, top ports, or side ports. First MEMS microphone 300 can be mounted or affixed to top surface 332 of PCB 330 such that its bottom sound port 310 is positioned over first slotted or concave recess 338 of PCB 330. Furthermore, second MEMS microphone 302 can be mounted or affixed to top surface 332 of PCB 330 such that its bottom sound port similar to 310 is positioned over second slotted or concave recess 339 of PCB 330. According to various embodiments, the difference in physical lengths for air-conduction sound propagation for speech frequencies entering the two microphone sound ports is less than 5 mm. First and second MEMS microphone may be positioned such that their respective sound ports are less than 5 mm apart.

FIG. 3D illustrates a side view of a proximate dual microphone system 360 as generally indicated with a second MEMS microphone 302 producing a second electrical signal 306 (see FIG. 3E), and a first MEMS microphone 300 (behind second MEMS microphone 302) producing a first electrical signal 304 (see FIG. 3E), and PCB 330 having a top surface 332, a bottom surface 334, and an edge surface 336 extending from top surface 332 to bottom surface 334.

In one example, the port holes of MEMS microphones 300 and 302 are positioned less than 3 mm apart from each other. As a result, air-conduction sounds 350 and 352 have nearly identical far-field acoustic path lengths from any point in space to the sound port openings of MEMS microphones 300 and 302. This is particularly the case for frequencies within the range of human speech.

FIG. 3E illustrates a schematic diagram 390 of proximate dual microphone system 360 which includes first MEMS microphone 300, first electrical signal 304, second MEMS microphone 302 and second electrical signal 306. Schematic function diagram 390 illustrates that first electrical signal 304 and second electrical signal 306 are added together 370 to create a summation electrical signal 380. It is noted that schematic function diagram 390 contains no delay element: thus, first electrical signal 304 and second electrical signal 306 are essentially in-phase and coherent with respect to a speech audio source. The summation electrical signal 380 of first electrical signal 304 and second electrical signal 306 causes an in-phase and coherent speech audio signal level of interest to increase by 6 dB. First MEMS microphone 300 produces a first EIN. Similarly, second MEMS microphone 302 produces a second EIN. First EIN and second EIN are incoherent and uncorrelated and consequentially the summation of the first and second EIN (when first signal 304 and second signal 306 are summed) will result in only an increase of about 3 dB of EIN within the resulting electrical summation signal 380. Therefore, proximate dual microphone system 360 lowers the effective EIN by 3 dB with respect to a speech audio signal. These effects become increasingly important for speech intelligibility in the far-field. With no delay element in schematic function diagram 390, a proximate dual microphone system 360 will exhibit an omnidirectional polar pattern for speech frequencies.

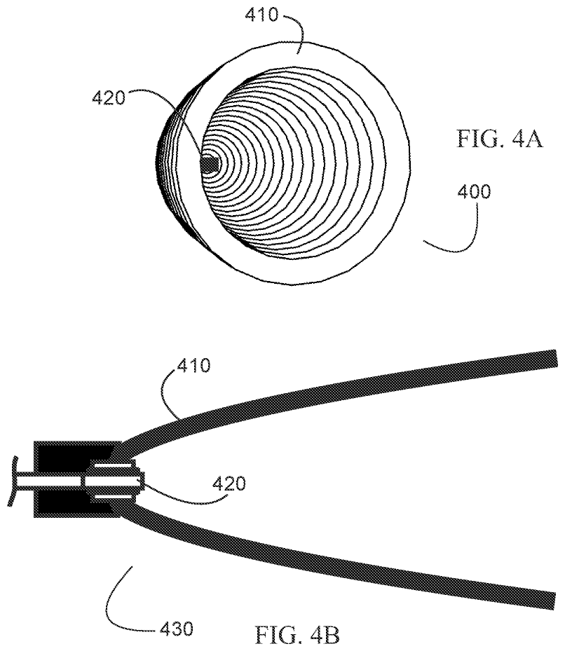

FIG. 4A illustrates a perspective view of an audio system 400 as generally indicated consisting of a passive acoustic directional amplifier 410 (e.g., passive acoustic directional amplifier 100 described in U.S. Patent Publication 2022/0225016) and a proximate dual microphone system 420 (e.g., proximate dual microphone system 160 as illustrated and described in relation to FIG. 1D, system 260 illustrated and described in 20) relation to FIG. 2D, or system 360 illustrated and described in relation to FIG. 3D). Combining a passive acoustic directional amplifier 410 with a proximate dual microphone system 420 combines key benefits from both elements resulting in reduced effective EIN, increased SNR in the output signal, and directional sensitivity.

FIG. 4B illustrates a cross-section view of an audio system 430 including passive acoustic directional amplifier 410 and proximate dual microphone system 420.

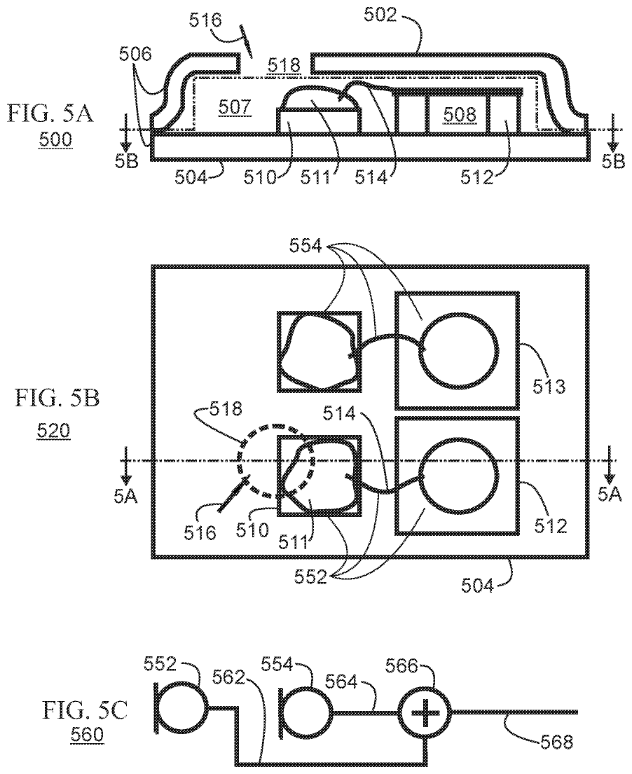

FIG. 5A illustrates a cross-sectional side view of proximate dual MEMS microphones 500 along line 5A-5A shown in FIG. 5B. In one example, proximate dual MEMS microphones 500 includes housing or case 502. Housing 502 can be mounted or affixed to a substrate 504. In one example, substrate 504 includes a printed circuit board (“PCB”). In one example, housing 502 can also be integral with substrate 504. Together, housing 502 and substrate 504 form proximate dual MEMS package 506.

Housing 502 defines an interior volume or front chamber 507 between housing 502 and substrate 504. A first MEMS sensor 512 and a second MEMS sensor (see FIG. 5B) may be located within the MEMS package 506. Each of the MEMS sensors may include a back chamber, such as back chamber 508 which is formed when MEMS sensor 512 is mounted or affixed to substrate 504. Front chamber 507 may contain an integrated circuit (“IC”) 510, such as an application specific integrated circuit (“ASIC”), and MEMS sensor 512. IC 510 and MEMS sensor 512 can be mounted or affixed to substrate 504. IC 510 and MEMS sensor 512 can be electronically coupled with bond wire(s) 514. Integrated circuit 510 may include circuitry for signal conditioning, an analog-to-digital conversion, decimation and anti-aliasing filtering, power management, and even an industry standard 24-bit I²S interface. In one example, integrated circuit 510 may include a glob top 511. Together, IC 510 and MEMS sensor 512 form a first MEMS microphone 552.

According to various embodiments, proximate dual MEMS package 506 forms a sound port, sound inlet, or port hole 518. Sound port 518 allows air-conducting sound 516 to enter proximate dual MEMS microphone system 500 and be converted into a first and second electrical signals 562 and 564 (see FIG. 5C). Port hole 518 may be completely devoid of material or alternatively may incorporate a screen or mesh. According to an example, port hole 518 forms a top port of a top port MEMS microphone. In another example, MEMS sensor 512 may also integrate or include additional circuitry for signal conditioning, analog-to-digital conversion, decimation and anti-aliasing filters, power management, and an industry standard 24-bit I²S interface such as that which might be performed separately by integrated circuit 510.

FIG. 5B illustrates a cross-sectional top view of first MEMS microphone 552 and a second MEMS microphone 554 along line 5B-5B shown in FIG. 5A which is made so that case 502 does not obscure top view 520 interior details. In one example, the proximate dual MEMS microphones system 520 measures 3.5 mm by 4 mm. In the present example, proximate dual MEMS microphones system 520 has a top port opening or sound port 518 through which air-conducting sound can enter. A first MEMS microphone 552 is shown configured in top view 520 with MEMS sensor 512, IC 510, glob top 511, bond wire 514 and are affixed to substrate 504 with a die attach material (not shown). In another example, MEMS sensor 512 may also integrate or include additional circuitry for signal conditioning, analog-to-digital conversion, decimation and anti-aliasing filters, power management, and/or an industry standard 24-bit I²S interface such as that which might be performed separately by integrated circuit 510. A second MEMS microphone 554 may be configured similar to first MEMS microphone 552. Proximate dual MEMS package 506 thus comprises a first MEMS microphone 552 and a second MEMS microphone 554. Sound port 518 allows air-conducting sound 516 to enter first MEMS microphone 552 and be converted into a first electrical signal 562 (see FIG. 5C) representing the sound and also allows air-conducting sound 516 to enter second MEMS microphone 554 and be converted into a second electrical signal 564 (see FIG. 5C) representing the sound. Although FIG. 5B does not depict sound port 518 as equidistant from each of the proximate dual MEMS microphones 552 and 554, it is preferable that sound port 518 is placed substantially equidistant from each of the sensors 512 and 513 of proximate dual MEMS microphones 552 and 554.

In another example, first and second MEMS microphones 552 and 554 are bottom port MEMS microphones, similar to MEMS microphone 100. However, according to this embodiment both MEMS microphones 552 and 554 are contained within a single proximate dual MEMS package 506, wherein the MEMS package has two bottom port holes. As a result, an air-conduction sound 516 has nearly identical far-field acoustic path lengths into both sound port openings.

In one example, first and second MEMS microphones 552 and 554 (including their respective components) are all formed on a single semiconductor die such that the die comprises two diaphragms and circuitry for signal conditioning, analog-to-digital conversion, decimation and anti-aliasing filters, power management, and an industry standard 24-bit I²S interface.

In another example, first MEMS microphone 552 is formed on a first semiconductor die, and second MEMS microphone 554 is formed on a second semiconductor die.

FIG. 5C illustrates a schematic diagram 560 for proximate dual microphones system 520. Proximate dual microphones system 520 comprises first MEMS microphone 552 which generates first signal 562, and second MEMS microphone 554 which generates a second signal 564. Schematic diagram 560 illustrates that first signal 562 and second signal 564 are added together 566 to create a summation signal 568. It is noted that schematic diagram 560 representing proximate dual microphones system 520 contains no delay element: thus, first electrical signal 562 and second electrical signal 564 are in-phase and coherent with respect to a speech source. As a result, the summation signal 568 for a speech source will be 6 dB greater than either of the in-phase and coherent components of signals 562 or 564 for a speech source.

On the other hand, EIN produced by first MEMS microphone 552 and EIN produced by second MEMS microphone 554 are incoherent and uncorrelated. As a result, these microphone self-noises will increase by only about 3 dB in summation signal 568. Thus, proximate dual microphones system 520) can increase the SNR by 3 dB with respect to EIN as compared to a system comprising only a single MEMS microphone. Proximate dual microphones system 520 lowers the effective EIN by 3 dB with respect to a desired signal. These effects become increasingly important for speech intelligibility in the far-field especially for high frequency components of a speech source. With no delay element in proximate dual microphones system 520, proximate dual microphones system 520 will exhibit an omnidirectional polar pattern for speech frequencies.

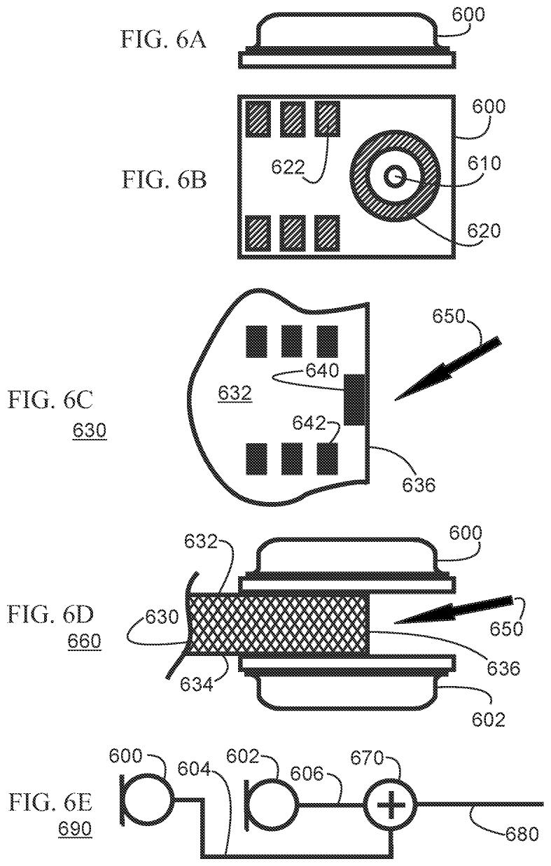

FIG. 6A illustrates a side view of a MEMS microphone 600. According to some examples, MEMS microphone 600 may comprise any conventional MEMS microphone

FIG. 6B illustrates a bottom view of MEMS microphone 600. In one example MEMS microphone 600 measures 3 mm by 4 mm. In the present example, MEMS microphone 600 has a bottom port opening 610 through which air-conducting sound can enter MEMS microphone 600 and be converted into first electrical signal such as first electrical signal 604 (see FIG. 6E). First MEMS microphone 600 has electrical contacts 620 and 622. In one example, electrical contacts 620 and 622 can be surface mount electrical connections. In one example, electrical contact 620 is the electrical ground connection for MEMS microphone 600. In one example, electrical contacts 620 and 622 are metal leads. In another example, electrical contacts 620 and 622 are solder bumps.

According to various embodiments, sound port opening 610 may be completely devoid of material or alternatively may incorporate a screen or mesh.

FIG. 6C illustrates a top view of a substrate 630. Substrate 630 has a top surface 632 and a bottom surface 634 opposite the top surface as shown in FIG. 6D. Substrate 630 has an edge surface 636 that extends from top surface 632 to bottom surface 634. Air-conducting sound 650) can approach edge surface 636 of substrate 630.

In one example, substrate 630 is a PCB. Substrate 630 can have electrical contacts such as electrical contacts 640 and 642. Electrical contacts 640 and 642 are shown using solid black filled markings. In one example, electrical contacts 640 and 642 are surface mount electrical pad connections.

Substrate 630 can be a double-sided PCB and can have similar surface mount electrical pad connections in a mirror arrangement on bottom surface 634 of substrate 630. Electrical PCB trace interconnections to electrical pad connections such as electrical contacts 640 and 642 are not shown for simplicity of the description. Similarly, other features such as solder mask layers have been omitted for simplicity.

FIG. 6D illustrates a side view of a proximate dual microphone system 660 comprising a first MEMS microphone 600 and a second MEMS microphone 602. In one example, each of first and second MEMS microphones 600 and 602 are bottom port MEMS microphones similar to MEMS microphone 600. Proximate dual microphone system 660 also comprises a double-sided PCB substrate such as substrate 630. PCB 630 can have a top surface 632 and a bottom surface 634 opposite top surface 632. PCB 630 can also have an edge surface 636 that extends from top surface 632 to bottom surface 634. First MEMS microphone 600 can be mounted or affixed to top surface 632 of substrate 630 such that a portion of first MEMS microphone 600 extends beyond PCB 630 and edge surface 636. First MEMS microphone 600 can be mounted or affixed to top surface 632 of substrate 630 such that sound port 610 of first MEMS microphone 600 is not overlying PCB 630. Second MEMS microphone 602 can be mounted or affixed to bottom surface 634 of substrate 630 such that a portion of second MEMS microphone 602 extends beyond PCB 630 and edge surface 636. Second MEMS microphone 602 can be mounted or affixed to bottom surface 634 of substrate 630 such that sound port 610 of second MEMS microphone 600 is not overlying PCB 630.

In one example, first MEMS microphone 600 and second MEMS microphone 602 are positioned such that sound port 610 of first MEMS microphone 600 is overlying sound port 610 of second MEMS microphone 602.

In one example, substrate 630) is about 1.6 mm thick, as a result the sound ports of MEMS microphone 600 and 602 are positioned less than 3 mm apart from each other. In another example, the sound ports of MEMS microphone 600 and 602 are positioned less than 5 mm apart. As a result, air-conduction sound 650 has nearly identical far-field acoustic path lengths into both sound port openings of MEMS microphones 600 and 602.

In one example, substrate 630 is about 1.6 mm thick, as a result the sound ports of MEMS microphones 600 and 602 are positioned less than 3 mm apart from each other. In another example, substrate 630 is less than 1 mm thick, as a result the sound ports of MEMS microphones 600 and 602 are positioned less than 1 mm apart from each other. In another example, the sound ports of MEMS microphone 600 and 602 are positioned less than 5 mm apart. As a result, air-conduction sound 650 has nearly identical far-field acoustic path lengths from any point in space to each of the sound port openings of MEMS microphones 600 and 602. This is particularly the case for frequencies within the range of human speech.

FIG. 6E illustrates a schematic diagram for proximate dual microphone system 690 which may, for example, correspond to proximate dual microphone system 660. Proximate dual microphone system 690 comprises first MEMS microphone 600 which generates first electrical signal 604, and second MEMS microphone 602 which generates a second electrical signal 606. Schematic diagram 690 illustrates that first electrical signal 604 and second electrical signal 606 are added together 670 to create a summation signal 680. It is noted that schematic diagram 690 representing proximate dual microphone system 660 contains no delay element: thus, first electrical signal 604 and second electrical signal 606 are in-phase and coherent with respect to a speech source. As a result, the summation signal 680 for a speech source will be about 6 dB greater than either of the in-phase and coherent components of electrical signals 604 or 606 for a speech source.

On the other hand, EIN produced by first MEMS microphone 600 and EIN produced by second MEMS microphone 602 are incoherent and uncorrelated. As a result, these microphone self-noises will increase by only about 3 dB in summation signal 680. Thus, proximate dual microphones system 660 can increase the SNR by 3 dB with respect to EIN as compared to a system comprising only a single MEMS microphone. Proximate dual microphones system 660 lowers the effective EIN by 3 dB with respect to a desired signal. These effects become increasingly important for speech intelligibility in the far-field especially for high frequency components of a speech source. With no delay element in proximate dual microphones system 660, proximate dual microphones system 660 will exhibit an omnidirectional polar pattern for speech frequencies.

In reference to all of the foregoing disclosure, the above-described embodiments enable solutions, improvements, and benefits to address many problems and issues affecting conventional audio systems and conventional audio devices and offer improved functionality for audio systems and audio devices, for example:

First, by minimizing the difference between two physical lengths for air-conduction sound propagation, proximate dual MEMS microphones have electrical signals that are in-phase and coherent for speech frequencies and summation of these signals improves the resulting electrical signal strength for speech by 6 dB.

Second, each of the dual MEMS microphone signals contains EIN which is incoherent and uncorrelated and consequentially these noises will only increase by 3 dB within the resulting electrical summation signal.

Third, proximate dual MEMS microphones with minimal differences between physical lengths for air-conduction speech sound propagation improve SNR by 3 dB with respect to EIN.

Fourth, proximate dual MEMS microphones with minimal differences between physical lengths for air-conduction speech sound propagation reduce EIN by 3 dB with respect to the resulting electrical summation of the speech signals.

Fifth, the sensitivity of proximate dual MEMS microphones for speech frequencies is 6 dB better than for individual MEMS microphones.

Sixth, as EIN does not diminish with increasing microphone to speaker's lips distance, the 3 dB effective reduction of EIN for proximate dual MEMS microphones becomes increasingly important for speech intelligibility as far-field distances increase.

Seventh, proximate dual MEMS microphones retain an omnidirectional polar pattern for speech frequencies.

Eighth, a proximate dual MEMS microphone solution is both smaller and less expensive when compared to a condenser microphone solution having a similar effective EIN.

Ninth, a proximate dual MEMS microphone solution will significantly improve the Speech Intelligibility Index (SII) for far-field communications.

Tenth, the benefits and improvements generated by a proximate dual MEMS microphone solution can be further enhanced when combined with a passive acoustic directional amplifier.

Eleventh, the benefits and improvements generated by a proximate dual MEMS microphone solution can be further extended to more than two microphones in proximate location such as an audio system that comprises the signal summation of three, four, or more MEMS microphones in close acoustical proximity such as when the acoustic path length between any pair of such microphones differs less than 5 millimeters.

In view of the above it is evident that a proximate dual MEMS microphone can improve at least the following characteristics of a conventional audio system: improved at-a-distance speech intelligibility, low effective EIN, low cost, small size, reduced signal processing, improved signal-to-noise, improved computer hearing, improved automatic speech recognition, improved natural language processing, and directional discrimination when combined with a passive acoustic directional amplifier.

While the subject matter of the invention is described with specific and example embodiments, the foregoing drawings and descriptions thereof depict only typical embodiments of the subject matter and are not therefore to be considered limiting of its scope. It is evident that many alternatives and variations will be apparent to those skilled in the art and that those alternatives and variations are intended to be included within the scope of the present invention. For example, some embodiments described herein include some elements or features but not other elements or features included in other embodiments, thus, combinations of features or elements of different embodiments are meant to be within the scope of the invention and are meant to form different embodiments as would be understood by those skilled in the art.

As the claims hereinafter reflect, inventive aspects may lie in less than all features of a single foregoing disclosed embodiment. Thus, the hereinafter expressed claims are hereby expressly incorporated into this Detailed Description, with each claim standing on its own as a separate embodiment of the invention.

What is claimed is:

1. An audio system, comprising:
a substrate having a first surface and a second surface opposite the first surface, wherein the substrate forms a hole extending from the first surface to the second surface;
a first MEMS microphone mounted to the first surface of the substrate, the first MEMS microphone comprising a first package, a first sensor, and a first integrated circuit, wherein the first package forms a first sound port and wherein the first sound port is positioned over the hole in the substrate;
a second MEMS microphone mounted to the second surface of the substrate, the second MEMS microphone comprising a second package, a second sensor, and a second integrated circuit, wherein the second package forms a second sound port and wherein the second sound port is positioned over the hole in the substrate, and wherein the second sound port is positioned within 3 millimeters of the first sound port.

2. The audio system of claim 1, wherein the first MEMS microphone is configured to generate a first output signal and wherein the second MEMS microphone is configured to generate a second output signal, and wherein the audio system is configured to sum the first output signal with the second output signal to create a summation signal.

3. The audio system of claim 2, wherein a third integrated circuit within the audio system creates the summation signal and wherein the audio system does not delay the first signal in relation to the second signal and does not delay the second signal in relation to the first signal, prior to generating the summation signal of the first and second signal.

4. The audio system of claim 1, wherein the substrate comprises a printed circuit board.

5. The audio system of claim 1, wherein the first MEMS microphone is a bottom port MEMS microphone.

6. The audio system of claim 1, further comprising a passive acoustic directional amplifier, wherein the first sound port of the first MEMS microphone and the second sound port of the second MEMS microphone are positioned within a cavity formed by the passive acoustic directional amplifier.

7. An audio system, comprising:
a substrate having a top surface, a bottom surface opposite the first surface and substantially parallel to the top surface, and an edge surface extending from the top surface to the bottom surface, wherein the edge surface defines a slotted recess extending into the substrate;
a first MEMS microphone mounted to the first surface of the substrate, the first MEMS microphone comprising a first package, a first sensor, and a first integrated circuit, wherein the first package forms a first sound port and wherein the first sound port is positioned over the slotted recess;
a second MEMS microphone mounted to the second surface of the substrate, the second MEMS microphone comprising a second package, a second sensor, and a second integrated circuit, wherein the second package forms a second sound port and wherein the second sound port is positioned over the slotted recess, and wherein the second sound port is positioned within 3 millimeters of the first sound port.

8. The audio system of claim 7, wherein the first MEMS microphone is configured to generate a first output signal and wherein the second MEMS microphone is configured to generate a second output signal, and wherein the audio system is configured to sum the first output signal with the second output signal to create a summation signal.

9. The audio system of claim 8, wherein a third integrated circuit within the audio system creates the summation signal and wherein the audio system does not delay the first signal in relation to the second signal and does not delay the second signal in relation to the first signal, prior to generating the summation signal of the first and second signal.

10. The audio system of claim 7, wherein the substrate comprises a printed circuit board.

11. The audio system of claim 7, wherein the first MEMS microphone is a bottom port MEMS microphone.

12. The audio system of claim 7, further comprising a passive acoustic directional amplifier, wherein the first sound port of the first MEMS microphone and the second sound port of the second MEMS microphone are positioned within a cavity formed by the passive acoustic directional amplifier.

13. An audio system, comprising:
a substrate having a top surface, a bottom surface opposite the first surface and substantially parallel to the top surface, and an edge surface extending from the top surface to the bottom surface;
a first MEMS microphone mounted to the first surface of the substrate, the first MEMS microphone comprising a first sound port and wherein a portion of the first MEMS microphone extends beyond the edge of the substrate such that the first sound port is not positioned over the substrate;
a second MEMS microphone mounted to the first surface of the substrate, the second MEMS microphone comprising a second sound port and wherein a portion of the second MEMS microphone extends beyond the edge of the substrate such that the second sound port is not positioned over the substrate, and wherein the second sound port is positioned within 3 millimeters of the first sound port.

14. The audio system of claim 13, wherein the first MEMS microphone is configured to generate a first output signal and wherein the second MEMS microphone is configured to generate a second output signal, and wherein the audio system is configured to sum the first output signal with the second output signal to create a summation signal.

15. The audio system of claim 14, wherein an integrated circuit within the audio system creates the summation signal and wherein the audio system does not delay the first signal in relation to the second signal and does not delay the second signal in relation to the first signal, prior to generating the summation signal of the first and second signal.

16. The audio system of claim 13, wherein the substrate comprises a printed circuit board.

17. The audio system of claim 13, wherein the first MEMS microphone is a bottom port MEMS microphone.

18. The audio system of claim 13, further comprising a passive acoustic directional amplifier, wherein the first sound port of the first MEMS microphone and the second sound port of the second MEMS microphone are positioned within a cavity formed by the passive acoustic directional amplifier.
